(19) United States
(12) Patent Application Publication
(10) Pub. No.: US 2023/0005350 A1
(43) Pub. Date: Jan. 5, 2023

(54) IDENTIFICATION OF GUNSHOTS DETECTED BY GUNSHOT LOCATION SYSTEM

(71) Applicants: Kevin S. Weaver, Kettering, OH (US); Ronald J. Miller, SR., Dayton, OH (US); Arijit Sengupta, Miami, FL (US)

(72) Inventors: Kevin S. Weaver, Kettering, OH (US); Ronald J. Miller, SR., Dayton, OH (US); Arijit Sengupta, Miami, FL (US)

(21) Appl. No.: 17/852,734

(22) Filed: Jun. 29, 2022

Related U.S. Application Data
(60) Provisional application No. 63/217,954, filed on Jul. 2, 2021.

(51) Int. Cl. G08B 17/08; G08B 27/00; G08B 5/22

(52) U.S. Cl. CPC G08B 17/08; G08B 27/005; G08B 5/223

(57) ABSTRACT

Systems, methods, and computer program products for detecting, locating, and identifying gunshots. In response to detecting a discharge of a firearm, a discharge alert indicating one or more characteristics of the discharge is transmitted to a gunshot location system. The one or more characteristics of the discharge are compared to one or more characteristics of one or more gunshots detected by the gunshot location system based on acoustic signals received at one or more listening stations. In response to finding a match between the one or more characteristics of the discharge and the one or more characteristics of acoustically detected gunshot, the gunshot is associated with the firearm.

The present application claims the benefit of co-pending U.S. Provisional Application Ser. No. 63/217,954, filed Jul. 2, 2021, the disclosure of which is incorporated by reference herein in its entirety.

### BACKGROUND

This invention generally relates to detection of gunshots and, in particular, to methods, systems, and computer program products for identifying the firearm and shooter associated with detected gunshots.

The use of gunshot location systems is increasing to assist law enforcement in detecting and responding to shooting events. These systems typically detect and locate gunshots based on acoustic signals received from listening stations dispersed in and around the area being monitored. To determine the location of a gunshot, the system triangulates acoustic signals from multiple listening stations. Gunshot location systems work reasonably well for their intended purpose. However, they can suffer from a lack of accuracy, and provide little information on detected gunshots other than an approximate location where the gunshot occurred.

Thus, there is a need for improved systems, methods, and computer program products for detecting, locating, and identifying gunshots.

### SUMMARY

The present invention overcomes the foregoing and other shortcomings and drawbacks of systems, methods, and computer program products heretofore known for use for detecting, locating, and identifying gunshots. While the present invention will be discussed in connection with certain embodiments, it will be understood that the present invention is not limited to the specific embodiments described herein.

In an embodiment of the invention, a system is provided. The system includes one or more processors and a memory coupled to the one or more processors. The memory includes program code that, when executed by the one or more processors, causes the system to transmit a discharge alert indicating one or more characteristics of the discharge to a gunshot location system in response to detecting a discharge of a firearm, compare the one or more characteristics of the discharge to one or more characteristics of one or more gunshots detected by the gunshot location system and, in response to finding a match between the one or more characteristics of the discharge and the one or more characteristics of a gunshot, associate the gunshot with the firearm.

In an aspect of the system, the one or more characteristics may include one or both of a location of the firearm and a time of occurrence of the discharge.

In another aspect of the system, the program code may further cause the system to detect an acoustic impulse at the firearm characteristic of the gunshot, transmit a detection alert to the gunshot location system including data defining a location of the firearm and a time the gunshot was detected, and determine the time and the location of the gunshot based at least in part on the data defining the location of the firearm and the time the gunshot was detected.

In another aspect of the system, the program code may further cause the system to display a map including one or more icons indicating a location on the map where a gunshot has occurred, and display an indication on the map indicating which gunshots are associated with the firearm and which gunshots are not associated with the firearm.

In another aspect of the system, the program code may further cause the system to use the location of the firearm to calibrate the gunshot location system.

In another embodiment of the invention, a method is provided. The method includes transmitting the discharge alert indicating the one or more characteristics of the discharge to the gunshot location system in response to detecting the discharge of the firearm, comparing the one or more characteristics of the discharge to the one or more characteristics of the one or more gunshots detected by the gunshot location system and, in response to finding the match between the one or more characteristics of the discharge and the one or more characteristics of the gunshot, associating the gunshot with the firearm.

In an aspect of the method, the one or more characteristics may include one or both of the location of the firearm and the time of occurrence of the discharge.

In another aspect of the method, the method may further include detecting the acoustic impulse characteristic of the gunshot at the firearm, transmitting the detection alert including data defining the location of the firearm and the time the gunshot was detected to the gunshot location system, and determining the time and the location of the gunshot based at least in part on the data defining the location of the firearm and the time the gunshot was detected.

In another aspect of the method, the method may further include displaying the map including the one or more icons indicating the location on the map where the gunshot has occurred and displaying the indication on the map indicating which gunshots are associated with the firearm and which gunshots are not associated with the firearm.

In another aspect of the method, the method may further include using the location of the firearm to calibrate the gunshot location system.

In another embodiment of the invention, a computer program product is provided. The computer program product includes a non-transitory computer-readable storage medium and program code stored on the non-transitory computer-readable storage medium. The program code, when executed by one or more processors, causes the one or more processors to transmit the discharge alert indicating the one or more characteristics of the discharge to the gunshot location system in response to detecting the discharge of a firearm, compare the one or more characteristics of the discharge to the one or more characteristics of the one or more gunshots detected by the gunshot location system and, in response to finding the match between the one or more characteristics of the discharge and the one or more characteristics of the gunshot, associate the gunshot with the firearm.

The above summary presents a simplified overview of some embodiments of the invention to provide a basic understanding of certain aspects of the invention discussed herein. The summary is not intended to provide an extensive overview of the invention, nor is it intended to identify any key or critical elements, or delineate the scope of the invention. The sole purpose of the summary is merely to present some concepts in a simplified form as an introduction to the detailed description presented below.

### BRIEF DESCRIPTION OF THE DRAWINGS

The accompanying drawings, which are incorporated in and constitute a part of this specification, illustrate various embodiments of the invention and, together with the general description of the invention given above, and the detailed description of the embodiments given below, serve to explain the embodiments of the invention.

FIG. 1 is a diagrammatic view of an operating environment including a firearm and a gunshot location system having a plurality of listening stations in communication with a gunshot location server.

FIG. 2 is a diagrammatic view illustrating additional details of the firearm of FIG. 1.

FIG. 3 is a flowchart of a process for determining if a firearm discharge detected by the gunshot location system of FIG. 1 was fired by a known firearm.

FIG. 4 is a diagrammatic view of a user interface for the gunshot location system of FIG. 1

FIG. 5 is a diagrammatic view of a computer that may be used to implement one or more of the components or processes shown in FIGS. 1-4.

It should be understood that the appended drawings are not necessarily to scale, and may present a somewhat simplified representation of various features illustrative of the basic principles of the invention. The specific design features of the sequence of operations disclosed herein, including, for example, specific dimensions, orientations, locations, and shapes of various illustrated components, may be determined in part by the particular intended application and use environment. Certain features of the illustrated embodiments may have been enlarged or distorted relative to others to facilitate visualization and a clear understanding.

### DETAILED DESCRIPTION

Embodiments of invention are directed to systems, methods, and software products for detecting, locating, and identifying sources of gunshots. Law enforcement officers are all too often involved in situations in which the officer must transmit a radio message indicating “shots fired”. Embodiments of the invention detect gunshots and automatically transmit an alert without the requirement for action by the officer. Gunshots originating from the firearm of a law enforcement officer can be distinguished by the system from those originating from other firearms based on information carried by the alert. This feature may provide actionable information to other police units, e.g., by allowing them to distinguish shots fired by friends from those fired by foes. Firearms including various features of embodiments of the invention may also be used as an additional listening station to aid in determining the location of any random fire that is within listening distance of the firearm. Officer locations may also be provided to emergency responders through “on screen” graphics, giving officers on scene a tactical advantage and providing an additional safeguard against friendly fire incidents.

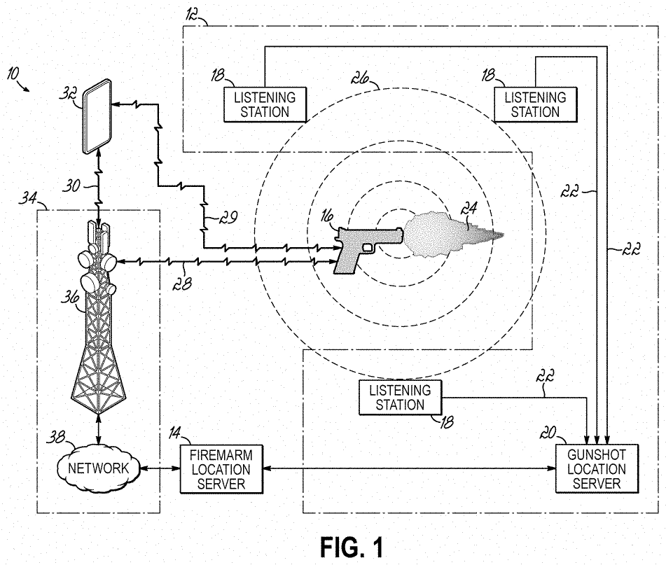

FIG. 1 depicts an operating environment 10 including a gunshot location system 12, a firearm location server 14, and a firearm 16 in accordance with an embodiment of the invention. The gunshot location system 12 includes a plurality of listening stations 18 in communication with a gunshot location server 20. Each listening station 18 has a known geographic location, and may be positioned to have an unobstructed view of the surrounding environment. By way of example, the listening stations 18 may be integrated with other devices, such as streetlights, traffic control device, etc., or otherwise attached to a utility pole or other object that places the listening station 18 at an elevated location above ground level. Each listening station 18 may include an acoustic sensor (e.g., microphone) that converts acoustic energy into electrical signals, and a transmitter that transmits information related to acoustic signals detected by the listening station 18 to the gunshot location server 20. This information may be transmitted via communication links 22. The communication links 22 may include one or more wired and/or wireless links, and may form part of a communication network. The information communicated from the listening stations 18 to the gunshot location server 20 may be carried by suitably encoded analog or digital signals, such as Internet Protocol (IP) packets.

A gunshot 24 generates an acoustic impulse 26 that radiates outward from the responsible firearm 16. The acoustic impulse 26 may reach the listening stations 18 at various times related to the distance between the listening station 18 and the gunshot 24. The gunshot location server 20 may receive information regarding one or more of a time of arrival, angle of arrival, and shape of the acoustic impulse 26 from each listening station 18. The gunshot location server 20 may then determine whether the acoustic impulse 26 is from a gunshot 24, and if so, further determine a location of the gunshot 24 using trilateration, triangulation, or any other suitable method of analyzing the received information. The location of the gunshot 24 may then be displayed to first responders and other emergency personnel, such as on a map. Gunshot location systems are described by U.S. Pat. No. 7,474,589 issued Jan. 6, 2009, and U.S. Pat. No. 7,855,935 issued Dec. 21, 2010, the disclosures of which are incorporated by reference herein in their entireties.

In an embodiment of the invention, the firearm 16 may be in communication with the firearm location server 14. To this end, the firearm 16 may transmit signals 28-30 to and receive signals 28-30 from a wireless system 34 (e.g., a cellular or Wi-Fi network). The signals 28-30 may be transmitted/received directly to/from the wireless system 34, or may be relayed by a mobile device 32, such as a smartphone carried by the owner of the firearm 16. The wireless system 34 may include one or more base stations 36 operatively coupled to a network 38. The firearm location server 14 may thereby receive information relating to one or more of a location of the firearm 16, a status of the firearm 16, and an event detected by the firearm 16 via the network 38.

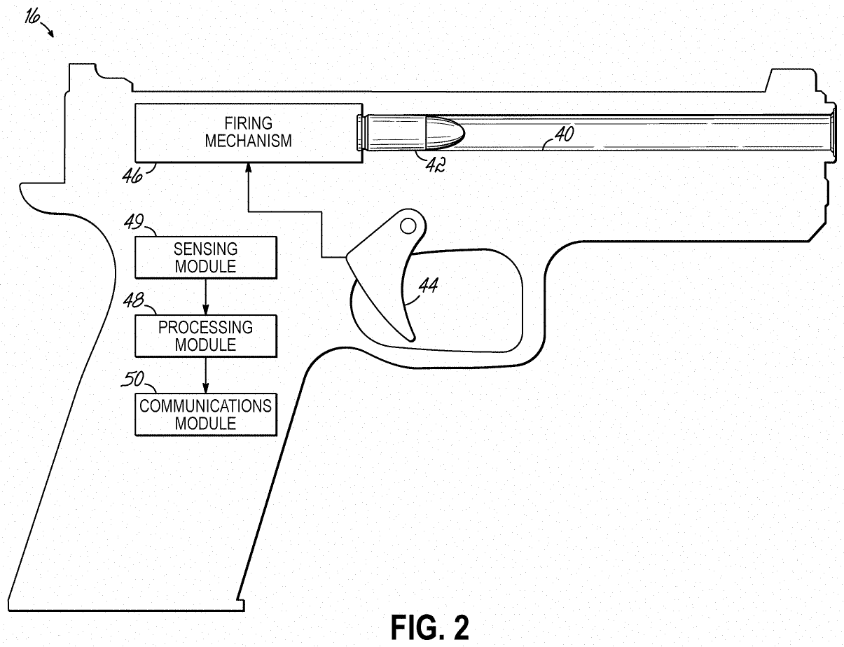

Referring now to FIG. 2, the firearm 16 may include a barrel 40 configured to receive a round 42 of ammunition, a trigger 44, and a firing mechanism 46 configured to fire the round 42 in response to activation of the trigger 44. The firearm 16 may further include a processing module 48, a sensing module 49, and a communication module 50. Each of the sensing and communication modules may be operatively coupled to the processing module 48. The firearm 16 may also include a power module (not shown) that provides power to each of the processing, sensor, and communication modules 48-50. The power module may include a power source, such as a battery, and a power port that replenishes the power source when connected to an external source of power.

The processing module 48 may include a processor and memory storing program code that, when executed by the processor, causes the processing module 48 to perform one or more functions that implement or otherwise provide various aspects of the embodiments of the invention described herein. The processing module 48 may determine the location of the firearm 16 based on information received from the sensing module 49, by querying the mobile device 32 for location information, or both based on information received from the sensing module 49 and by querying the mobile device 32 for location information. The processing module 48 may also include a clock that provides time stamps for detected events. When present, the clock may be set or updated based on signals received from the mobile device 32 or another external system, such as wireless system 34.

The sensing module 49 may include one or more sensors each configured to detect certain aspects of the state of the firearm 16 and the environment proximate to the firearm 16. Exemplary sensors may include an acoustic transducer configured to receive or emit acoustic signals, an accelerometer configured to detect motion or vibrations, a motion sensor, and a geolocation sensor. The motion sensor may be a six degrees-of-freedom (6 DoF) inertial sensor configured to detect movement of the firearm 16. The geolocation sensor may include a Global Positioning System (GPS) or other geolocation system receiver configured to determine a location of the firearm 16 based on signals received from external sources, e.g., satellites or terrestrial transmitters. Exemplary methods and systems for determining a location using a wireless network are disclosed by U.S. Pat. No. 8,700,060, the disclosure of which is incorporated by reference herein in its entirety.

The accelerometer, or an axis of the motion sensor, may be aligned with the barrel 40 to detect recoil resulting from discharging the firearm 16. Discharges may also be detected using micro-switches or other sensors configured to detect activation of the trigger 44, movement in the firing mechanism 46, or movement of the slide of the firearm 16. Discharges may also be detected based on acoustic signals received by the sensing module 49. Gunshots from other firearms may also be detected acoustically by the sensing module 49. These gunshots may be distinguished from shots fired from the firearm 16 based on amplitude or any other suitable characteristic. Systems and methods for detecting a firearm discharge are described by U.S. Pat. No. 8,826,575 issued Sep. 9, 2014, U.S. Pat. No. 7,669,356 issued Mar. 2, 2010, and U.S. Pat. No. 7,509,766 issued Mar. 31, 2009, the disclosures of which are incorporated by reference herein in their entireties.

The communication module 50 may be configured to communicate with one or both of the mobile device 32 and wireless system 34 using a suitable communication protocol. These protocols may include short-range wireless protocols (e.g., Bluetooth, Near-Field Communication (NFC), Radio-Frequency Identification (RFID)), a cellular network communication protocol (e.g., 4G, 5G), a local wireless network protocol (e.g., Wi-Fi), etc. Short range protocols may be used, for example, to communicate with the mobile device 32, or an NFC or RFID device worn by authorized users of the firearm 16, e.g., police officers. These types of identification devices may identify the user of the firearm 16, and enable the processing module 48 to either enable or disable the firearm 16 depending on the presence or absence of an authorized user. Systems and methods for controlling operation of a firearm using identification devices are described by U.S. Pat. No. 10,837,723, issued Nov. 17, 2020, the disclosure of which is incorporated by reference herein in its entirety.

In an embodiment of the invention, the processing module 48 may analyze acoustic signals detected by sensing module 49 to determine if any gunshots have occurred within listening distance of the firearm 16. If a gunshot from another gun is detected, the firearm 16 may transmit a detection alert including information on the gunshot and the location of the firearm 16. This information may include data defining a waveform of the acoustic impulse, a time of arrival, and an angle of arrival. Waveform information may include digitized samples of the waveform, as well as data defining the amplitude, duration, frequency content, rise times, or any other characteristic of the waveform. Methods and systems for analyzing acoustic impulses associated with gunshots are described by U.S. Pat. No. 7,586,812, issued Sep. 8, 2009, the disclosure of which is incorporated by reference herein in its entirety. The gunshot and location information received from the firearm 16 may be forwarded to the gunshot location server 20. This information may be added to the data received from the listening stations 18 for use in identifying and locating the gunshot. The firearm 16 may thereby serve as an additional listening station for the gunshot location system 12.

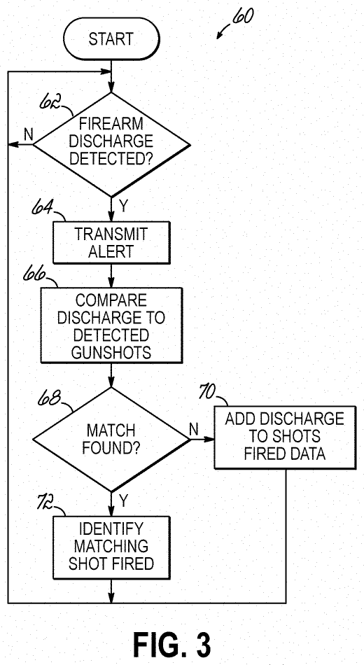

FIG. 3 depicts a flowchart illustrating a process 60 that may be implemented by one or more of the firearm location server 14, gunshot location server 20, mobile device 32, processing module 48 of firearm 16, or any other suitable computer of operating environment 10. In block 62, the process 60 determines if the firearm 16 has been discharged. The process 60 may make this determination by sensing recoil, movement or activation of a component of the firearm, detecting an acoustic impulse characteristic of a discharge, or any other suitable event. If a discharge has not been detected (“NO” branch of decision block 62), the process 60 continues monitoring for a firearm discharge or other event of interest, e.g., detection of an acoustic impulse characteristic of a gunshot.

If a discharge has been detected (“YES” branch of decision block 62), the process 60 proceeds to block 64 and transmits a discharge alert. The discharge alert may include data indicative of the discharge, a location of the discharge, a time of the discharge, and an identity of the firearm 16 or the person in possession of the firearm 16. The discharge alert may be transmitted from the firearm 16 to the firearm location server 14 directly through the wireless system 34. The alert may also or alternatively be received from the firearm 16 by the mobile device 32, and forwarded from the mobile device 32 to the firearm location server 14 through the wireless system 34. For embodiments in which alerts are relayed through the mobile device 32, the mobile device 32 may add information to the alert, such as the location of the discharge, the time of the discharge, and an identity of the mobile device 32 (e.g., a phone number) or firearm user. In an embodiment of the invention, the mobile device 32 may also detect the discharge (e.g., by receiving an acoustic signal characteristic of a discharge from the firearm 16), in which case the alert may be initiated by the mobile device 32.

In response to receiving or transmitting the discharge alert, the process 60 proceeds to block 66 and compares one or more characteristics of the discharge to corresponding characteristics of gunshots detected by the gunshot location system 12. These characteristics may include, for example, the location and time of occurrence of the discharge. This comparison may be performed, for example, by the firearm location server 14 or gunshot location server 20 in response to receiving the discharge alert. In cases where the comparison is performed by the firearm location server 14, the firearm location server 14 may query the gunshot location server 20 for the time and location of detected gunshots in response to receiving the alert.

In block 68, the process 60 determines if a gunshot detected by the gunshot location system 12 matches the discharge associated with the discharge alert. A match may occur, for example, if the location of the detected gunshot is within a threshold distance of the location identified by the discharge alert (e.g., within 10, 20, 50 or 100 meters), is within a threshold time window of the time of occurrence identified by the alert (e.g., within plus-or-minus 1, 2, 5, or 10 seconds), or is within both a threshold distance and a threshold time window.

If the characteristics of the discharge do not match those of a detected gunshot (“NO” branch of decision block 68), the process 60 proceeds to block 70, adds the discharge to the shots fired data maintained by the gunshot location server 20, and continues monitoring for discharges of firearm 16. If the characteristics of the discharge match those of a detected gunshot (“YES” branch of decision block 68), the process 60 proceeds to block 72, identifies the matching gunshot as having been fired by firearm 16, and returns to monitoring for discharges of firearm 16.

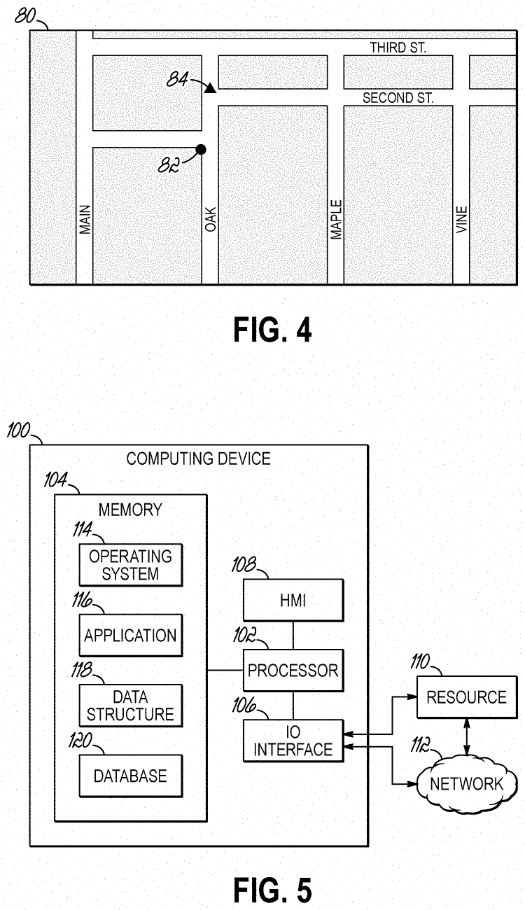

FIG. 4 depicts a user interface of the gunshot location system 12 including an exemplary window 80 that may be displayed to a user of the system, such as a 911 operator, a police dispatcher, or a police officer responding to the scene. In cases where the user is mobile, the window may be displayed on the mobile device 32. Any authorized user may view the map in real-time, for example, by logging into a website provided by the gunshot location system 12 and entering their credentials, e.g., user identity and password.

The above “on-screen” location tracking enables the user to identify relative locations of gunshots detected by or otherwise provided to the gunshot location system 12. The window 80 may include a map that displays one or more icons 82, 84 each indicating the location of gunshots. If the identity of the firearm that generated the gunshot is unknown, the icon may have a shape or color indicating this fact. If, on the other hand, the identity of the firearm or the user of the firearm which generated the gunshot is known (e.g., because it matches an alert received from the firearm location server 14), the icon may have a different shape or color indicating the gunshot is associated with the known firearm or user. The window 80 may also display a balloon or other text field with information such as the name of the officer believed to have fired the shot represented by the icon 82, 84. This information may allow the user to determine which gunshots are associated with police activity, and which are associated with civilian activity. This information may also enable the user to help coordinate responses to shots fired incidents.

In addition to enabling users of the gunshot location system 12 to identify gunshots generated by police officers responding to a crime scene, embodiments of the invention may also facilitate calibration of the listening stations 18 of gunshot location system 12. The location of a discharge provided by a discharge alert received from the firearm 16 or mobile device 32 may, in many cases, be more accurate or precise than the location of the gunshot determined from the acoustic impulses 26 received by the listening stations 18. This improved accuracy/precision may be due to how the location is determined, e.g., using GPS signals verses triangulation of acoustic impulses 26. Thus, the location of a discharge matching a detected gunshot may be used to calibrate the gunshot detection algorithm used by the gunshot location server 20 to locate gunshots.

Referring now to FIG. 5, embodiments of the invention described above, or portions thereof, may be implemented using one or more computer devices or systems, such as exemplary computer 100. The computer 100 may include a processor 102, a memory 104, an input/output (I/O) interface 106, and a Human Machine Interface (HMI) 108. The computer 100 may also be operatively coupled to one or more external resources 110 via the network 112 or I/O interface 106. External resources may include, but are not limited to, servers, databases, mass storage devices, peripheral devices, cloud-based network services, or any other resource that may be used by the computer 100.

The processor 102 may include one or more devices selected from microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on operational instructions stored in memory 104. Memory 104 may include a single memory device or a plurality of memory devices including, but not limited to, read-only memory (ROM), random access memory (RAM), volatile memory, non-volatile memory, static random access memory (SRAM), dynamic random access memory (DRAM), flash memory, cache memory, or data storage devices such as a hard drive, optical drive, tape drive, volatile or non-volatile solid state device, or any other device capable of storing data.

The processor 102 may operate under the control of an operating system 114 that resides in memory 104. The operating system 114 may manage computer resources so that computer program code embodied as one or more computer software applications, such as an application 116 residing in memory 104, may have instructions executed by the processor 102. In an alternative embodiment, the processor 102 may execute the application 116 directly, in which case the operating system 114 may be omitted. One or more data structures 118 may also reside in memory 104, and may be used by the processor 102, operating system 114, or application 116 to store or manipulate data.

The I/O interface 106 may provide a machine interface that operatively couples the processor 102 to other devices and systems, such as the external resource 110 or the network 112. The application 116 may thereby work cooperatively with the external resource 110 or network 112 by communicating via the I/O interface 106 to provide the various features, functions, applications, processes, or modules comprising embodiments of the invention. The application 116 may also have program code that is executed by one or more external resources 110, or otherwise rely on functions or signals provided by other system or network components external to the computer 100. Indeed, given the nearly endless hardware and software configurations possible, persons having ordinary skill in the art will understand that embodiments of the invention may include applications that are located externally to the computer 100, distributed among multiple computers or other external resources 110, or provided by computing resources (hardware and software) that are provided as a service over the network 112, such as a cloud computing service.

The HMI 108 may be operatively coupled to the processor 102 of computer 100 to allow a user to interact directly with the computer 100. The HMI 108 may include video or alphanumeric displays, a touch screen, a speaker, and any other suitable audio and visual indicators capable of providing data to the user. The HMI 108 may also include input devices and controls such as an alphanumeric keyboard, a pointing device, keypads, pushbuttons, control knobs, microphones, etc., capable of accepting commands or input from the user and transmitting the entered input to the processor 102.

A database 120 may reside in memory 104, and may be used to collect and organize data used by the various systems and modules described herein. The database 120 may include data and supporting data structures that store and organize the data. In particular, the database 120 may be arranged with any database organization or structure including, but not limited to, a relational database, a hierarchical database, a network database, or combinations thereof. A database management system in the form of a computer software application executing as instructions on the processor 102 may be used to access the information or data stored in records of the database 120 in response to a query, which may be dynamically determined and executed by the operating system 114, other applications 116, or one or more modules.

In general, the routines executed to implement the embodiments of the invention, whether implemented as part of an operating system or a specific application, component, program, object, module or sequence of instructions, or a subset thereof, may be referred to herein as “computer program code,” or simply “program code.” Program code typically comprises computer-readable instructions that are resident at various times in various memory and storage devices in a computer and that, when read and executed by one or more processors in a computer, cause that computer to perform the operations necessary to execute operations or elements embodying the various aspects of the embodiments of the invention. Computer-readable program instructions for carrying out operations of the embodiments of the invention may be, for example, assembly language, source code, or object code written in any combination of one or more programming languages.

Various program code described herein may be identified based upon the application within which it is implemented in specific embodiments of the invention. However, it should be appreciated that any particular program nomenclature which follows is used merely for convenience, and thus the invention should not be limited to use solely in any specific application identified or implied by such nomenclature. Furthermore, given the generally endless number of manners in which computer programs may be organized into routines, procedures, methods, modules, objects, and the like, as well as the various manners in which program functionality may be allocated among various software layers that are resident within a typical computer (e.g., operating systems, libraries, API's, applications, applets, etc.), it should be appreciated that the embodiments of the invention are not limited to the specific organization and allocation of program functionality described herein.

The program code embodied in any of the applications/modules described herein is capable of being individually or collectively distributed as a computer program product in a variety of different forms. In particular, the program code may be distributed using a computer-readable storage medium having computer-readable program instructions thereon for causing a processor to carry out aspects of the embodiments of the invention.

Computer-readable storage media, which is inherently non-transitory, may include volatile and non-volatile, and removable and non-removable tangible media implemented in any method or technology for storage of data, such as computer-readable instructions, data structures, program modules, or other data. Computer-readable storage media may further include RAM, ROM, erasable programmable read-only memory (EPROM), electrically erasable programmable read-only memory (EEPROM), flash memory or other solid state memory technology, optical storage devices, magnetic storage devices, or any other medium that can be used to store data and which can be read by a computer. A computer-readable storage medium should not be construed as transitory signals per se (e.g., radio waves or other propagating electromagnetic waves, electromagnetic waves propagating through a transmission media such as a waveguide, or electrical signals transmitted through a wire). Computer-readable program instructions may be downloaded to a computer, another type of programmable data processing apparatus, or another device from a computer-readable storage medium or to an external computer or external storage device via a network.

Computer-readable program instructions stored in a computer-readable medium may be used to direct a computer, other types of programmable data processing apparatuses, or other devices to function in a particular manner, such that the instructions stored in the computer-readable medium produce an article of manufacture including instructions that implement the functions, acts, or operations specified in the flow-charts, sequence diagrams, or block diagrams. The computer program instructions may be provided to one or more processors of a general purpose computer, a special purpose computer, or other programmable data processing apparatus to produce a machine, such that the instructions, which execute via the one or more processors, cause a series of computations to be performed to implement the functions, acts, or operations specified in the flow-charts, sequence diagrams, or block diagrams.

In certain alternative embodiments, the functions, acts, or operations specified in the flow-charts, sequence diagrams, or block diagrams may be re-ordered, processed serially, or processed concurrently consistent with embodiments of the invention. Moreover, any of the flow-charts, sequence diagrams, or block diagrams may include more or fewer blocks than those illustrated consistent with embodiments of the invention.

The terminology used herein is for the purpose of describing particular embodiments only and is not intended to be limiting of the embodiments of the invention. As used herein, the singular forms “a”, “an” and “the” are intended to include both the singular and plural forms, and the term “or” is intended to include both alternative and conjunctive combinations, unless the context clearly indicates otherwise. It will be further understood that the terms “comprises” or “comprising,” when used in this specification, specify the presence of stated features, integers, actions, steps, operations, elements, or components, but do not preclude the presence or addition of one or more other features, integers, actions, steps, operations, elements, components, or groups thereof. Furthermore, to the extent that the terms “includes”, “having”, “has”, “with”, “comprised of”, or variants thereof are used in either the detailed description or the claims, such terms are intended to be inclusive in a manner similar to the term “comprising”.

While all the invention has been illustrated by a description of various embodiments, and while these embodiments have been described in considerable detail, the scope of the appended claims is not restricted or in any way limited to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the spirit or scope of the general inventive concept.

What is claimed is:

1. A system comprising:
one or more processors; and
a memory coupled to the one or more processors and including program code that, when executed by the one or more processors, causes the system to:
in response to detecting a discharge of a firearm, transmit a discharge alert indicating one or more characteristics of the discharge to a gunshot location system;
compare the one or more characteristics of the discharge to one or more characteristics of one or more gunshots detected by the gunshot location system; and
in response to finding a match between the one or more characteristics of the discharge and the one or more characteristics of a gunshot, associate the gunshot with the firearm.

2. The system of claim 1, wherein the one or more characteristics include one or both of a location of the firearm and a time of occurrence of the discharge.

3. The system of claim 1, wherein the program code further causes the system to:
detect an acoustic impulse at the firearm, the acoustic impulse being characteristic of the gunshot;
transmit a detection alert to the gunshot location system, the detection alert including data defining a location of the firearm and a time the gunshot was detected; and
determine the time and the location of the gunshot based at least in part on the data defining the location of the firearm and the time the gunshot was detected.

4. The system of claim 1, wherein the program code further causes the system to:
display a map including one or more icons indicating a location on the map where a gunshot has occurred; and
display an indication on the map indicating which gunshots are associated with the firearm and which gunshots are not associated with the firearm.

5. The system of claim 1, wherein the discharge alert includes data indicative of a location of the firearm, and the program code further causes the system to:
use the location of the firearm to calibrate the gunshot location system.

6. A method comprising:
in response to detecting a discharge of a firearm, transmitting a discharge alert indicating one or more characteristics of the discharge to a gunshot location system;
comparing the one or more characteristics of the discharge to one or more characteristics of one or more gunshots detected by the gunshot location system; and
in response to finding a match between the one or more characteristics of the discharge and the one or more characteristics of a gunshot, associating the gunshot with the firearm.

7. The method of claim 6, wherein the one or more characteristics include one or both of a location of the firearm and a time of occurrence of the discharge.

8. The method of claim 7, further comprising:
detecting an acoustic impulse at the firearm, the acoustic impulse being characteristic of the gunshot;
transmitting a detection alert to the gunshot location system, the detection alert including data defining the location of the firearm and a time the gunshot was detected; and
determining the time and the location of the gunshot based at least in part on the data defining the location of the firearm and the time the gunshot was detected.

9. The method of claim 6, further comprising:
displaying a map including one or more icons indicating a location on the map where a gunshot has occurred; and
displaying an indication on the map indicating which gunshots are associated with the firearm and which gunshots are not associated with the firearm.

10. The method of claim 6, wherein the discharge alert includes data indicative of a location of the firearm, and further comprising:
using the location of the firearm to calibrate the gunshot location system.

11. A computer program product comprising:
a non-transitory computer-readable storage medium; and
program code stored on the non-transitory computer-readable storage medium that, when executed by one or more processors, causes the one or more processors to:
in response to detecting a discharge of a firearm, transmit a discharge alert indicating one or more characteristics of the discharge to a gunshot location system;
compare the one or more characteristics of the discharge to one or more characteristics of one or more gunshots detected by the gunshot location system; and
in response to finding a match between the one or more characteristics of the discharge and the one or more characteristics of a gunshot, associate the gunshot with the firearm.
